(19) United States
(12) Patent Application Publication
(10) Pub. No.: US 2013/0286335 A1
(43) Pub. Date: Oct. 31, 2013

(54) DISPLAY DEVICE

(71) Applicant: PANASONIC LIQUID CRYSTAL DISPLAY CO., LTD., Hyogo (JP)

(72) Inventor: Toshiki ONISHI, Osaka (JP)

(73) Assignee: Panasonic Liquid Crystal Display Co., Ltd., Hyogo (JP)

(21) Appl. No.: 13/867,396

(22) Filed: Apr. 22, 2013

(30) Foreign Application Priority Data
Apr. 25, 2012 (JP) 2012-099699

(51) Int. Cl. G02F 1/1335

(52) U.S. Cl. CPC G02F 1/133514
USPC 349/108

(57) ABSTRACT

The present implementation discloses a display device including first pixels each of which has a first emission region for emitting image light for displaying an image; and second pixels each of which has a second emission region for emitting the image light. Each of the first and second pixels has optical transmission sections which emit different image lights in hue from each other. The optical transmission sections forms a first transmission region for emitting an image light of a hue which has a predetermined contribution ratio to luminance, and a second transmission region for emitting an image light of a hue with a contribution ratio higher than that of the first transmission region. The first emission region is narrower than the second emission region by a difference in area size between the first transmission regions in the first and second emission regions.

### BACKGROUND

1. Technical Field

The present disclosure relates to a display device for displaying images.

2. Description of the Related Art

Development of minute machining technologies enables to form fine pixels. As a result of pixel miniaturization, display devices may display images with high resolution.

Liquid crystal display devices which use liquid crystal to display images are known as display devices. A liquid crystal display device includes a pair of substrates, a liquid crystal layer formed between the substrates, and a spacer for maintaining a thickness of the liquid crystal layer. When the thickness of the liquid crystal layer is changed by a pressure applied to the display surface on which an image is displayed, the spacer contributes to restoration of the thickness of the liquid crystal layer (c.f. JP 10-68955 A).

Organic EL display devices which use organic EL (electroluminescence) elements to display images are known as other display devices. An organic EL display device includes a pair of substrates and organic EL elements situated between the substrates. Like the liquid crystal display device, the organic EL display device further includes a spacer for maintaining a gap between the substrates. The spacer of the organic EL display device contributes to protection of the organic EL element and other elements (c.f. JP 2005-294057 A).

Touch panel devices are known as other display devices. A touch panel device includes a sensor for detecting a movement of an object (e.g. user's hands or an auxiliary touch pen) on the display surface on which images are displayed. The touch panel device may execute various operations in response to detection results from the sensor.

Size reduction of the aforementioned spacer and sensor may be independent from the miniaturization of pixels. If pixels are much smaller than parts such as the spacer and sensor, the spacer and sensor may partially or entirely interfere with the pixels. Because of the interference of parts such as the spacer and sensor with the pixels, an observer observing images may perceive presence of these parts in the images.

### SUMMARY

In one general aspect, the instant application describes a display device that includes first pixels each of which has a first emission region configured to emit image light for displaying an image; and second pixels each of which has a second emission region configured to emit the image light, wherein each of the first pixels and each of second pixels have optical transmission sections which emit different image lights in hue from each other, the optical transmission sections forms a first transmission region configured to emit an image light of a hue which has a predetermined contribution ratio to luminance, and a second transmission region configured to emit an image light of a hue with a contribution ratio higher than that of the first transmission region, and the first emission region is narrower than the second emission region by a difference in area size between the first transmission regions in the first and second emission regions.

The aforementioned display device may display high quality images.

Objects, features, and advantages of the present disclosure will become more apparent from the following detailed description and the appended drawings.

### BRIEF DESCRIPTION OF THE DRAWINGS

FIG. 1 is a schematic cross-sectional view of a liquid crystal panel exemplified as the display device according to the first embodiment;

FIG. 2 is a schematic perspective view of a liquid crystal display incorporating the liquid crystal panel shown in FIG. 1;

FIG. 3 is a schematic view of pixels of the liquid crystal panel shown in FIG. 2;

FIG. 4A is a schematic view of a second pixel used as the pixel shown in FIG. 3;

FIG. 4B is a schematic view of an emission region of the second pixel shown in FIG. 4A;

FIG. 5A is a schematic view of the first pixel used as the pixel shown in FIG. 3;

FIG. 5B is a schematic view of an emission region of the first pixel shown in FIG. 5A;

FIG. 6A is a schematic view of pixel arrangement in the liquid crystal panel shown in FIG. 1;

FIG. 6B is a schematic view of pixel arrangement in another liquid crystal panel;

FIG. 7A shows simulation results for an image formed on a display surface under display of a white image on the liquid crystal panel depicted in FIG. 6A;

FIG. 7B shows simulation results for an image formed on the display surface under display of a white image on the liquid crystal panel depicted in FIG. 6B;

FIG. 8 is a schematic view of pixel arrangement in a liquid crystal panel exemplified as the display device according to the second embodiment; and

FIG. 9 is a schematic view of pixel arrangement in another liquid crystal panel exemplified as the display device of the second embodiment.

### DETAILED DESCRIPTION

Exemplary display devices are described below with reference to the drawings. In the following embodiments, similar constituent elements are assigned with similar reference numerals. Redundant explanation is omitted as appropriate to clarify the description. Configurations, arrangements and shapes shown in the drawings and description relating to the drawings aim to make principles of the embodiments easily understood. Therefore, the principles of the present embodiments are not limited thereto.

### First Embodiment

### (Display Device)

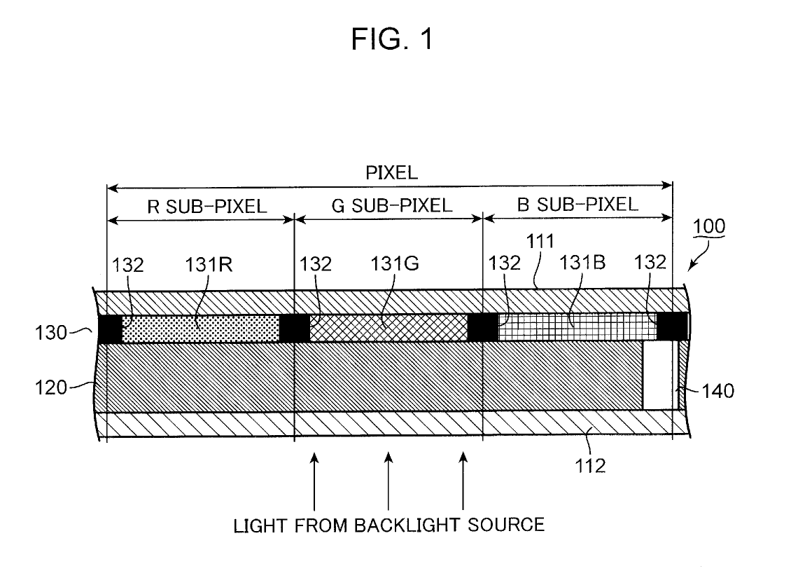

FIG. 1 is a schematic cross-sectional view of a liquid crystal panel 100 exemplified as the display device according to the first embodiment. The liquid crystal panel 100 is described with reference to FIG. 1.

The liquid crystal panel 100 includes a first substrate 111, which defines a display surface to display images, and a second substrate 112 facing the first substrate 111. The liquid crystal panel 100 further includes a liquid crystal layer 120 formed between the first and second substrates 111, 112. The liquid crystal layer 120 is adjacent to the second substrate 112. The liquid crystal layer 120 adjusts polarization directions of light transmitted through the second substrate 112 in response to a voltage applied to the liquid crystal layer 120.

The liquid crystal panel 100 further includes a filter layer 130 formed between the first and second substrates 111, 112. The filter layer 130 is adjacent to the first substrate 111. The filter layer 130 includes an R filter 131R from which light passing through the liquid crystal layer 120 is emitted as image light of a red hue (referred to as “red light” hereinafter), a G filter 131G from which light passing through the liquid crystal layer 120 is emitted as image light of a green hue (referred to as “green light” hereinafter), and a B filter 131B from which light passing through the liquid crystal layer 120 is emitted 120 as image light of a blue hue (referred to as “blue light” hereinafter). The filter layer 130 further includes a black matrix 132 compartmentalizing the R, G and B filters 131R, 131G, 131B. The black matrix 132 is likely to prevent mixture among the red, green and blue lights. In the present embodiment, the R, G and B filters 131R, 131G, 131B are exemplified as the optical transmission sections emitting different image lights in hue from each other. The R filter 131R is exemplified as the red filter. The G filter 131G is exemplified as the green filter. The B filter 131B is exemplified as the blue filter.

In the following description, the region defined by the R filter 131R compartmentalized by the black matrix 132 is referred to as “R sub-pixel”. The region defined by the G filter 131G compartmentalized by the black matrix 132 is referred to as “G sub-pixel”. The region defined by the B filter 131B compartmentalized by the black matrix 132 is referred to as “B sub-pixel”. A region including one R sub-pixel, one G sub-pixel, and one B sub-pixel is called “pixel”.

In the present embodiment, each pixel of the liquid crystal panel 100 includes three sub-pixels. Alternatively, the display device may include no more than two sub-pixels. The display device may include no less than four sub-pixels.

The liquid crystal panel 100 further includes a columnar spacer 140 situated between the filter layer 130 adjacent to the first substrate 111 and the second substrate 112. The spacer 140 maintains a thickness (referred to as “gap” hereinafter) of the liquid crystal layer 120 formed between the first and second substrates 111, 112. The spacer 140 may have a spacer structure used in well-known liquid crystal panels.

In the present embodiment, each pixel of the liquid crystal panel 100 are much smaller than the spacer 140. Therefore, a part of the spacer 140 enters in the B sub-pixel.

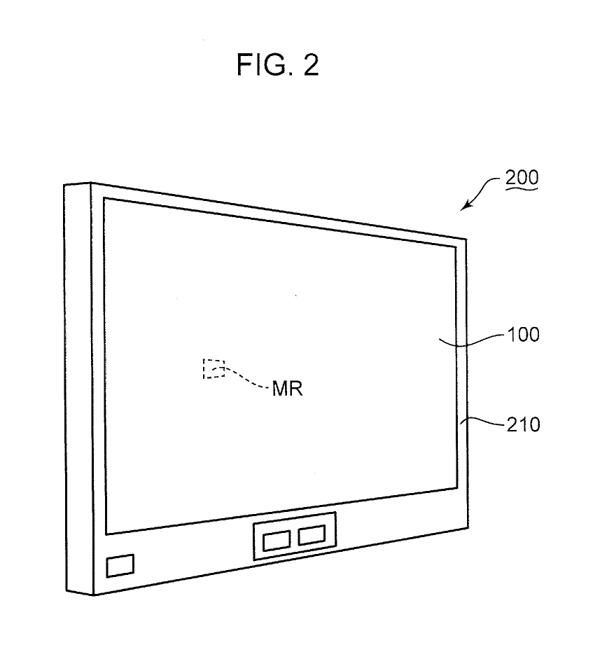

FIG. 2 is a schematic perspective view of a liquid crystal display 200 incorporating the liquid crystal panel 100. The liquid crystal display 200 is described with reference to FIG. 2.

In addition to the liquid crystal panel 100, the liquid crystal display 200 includes a housing 210 supporting the liquid crystal panel 100 and the aforementioned backlight source. The backlight source is stored inside the housing 210.

### (Pixels)

A rectangular frame MR depicted by a dot line is shown on the liquid crystal panel 100 in FIG. 2. Pixels in the rectangular frame MR are described below. Description about the pixels in the rectangular frame MR may be similarly applied to pixels in other regions.

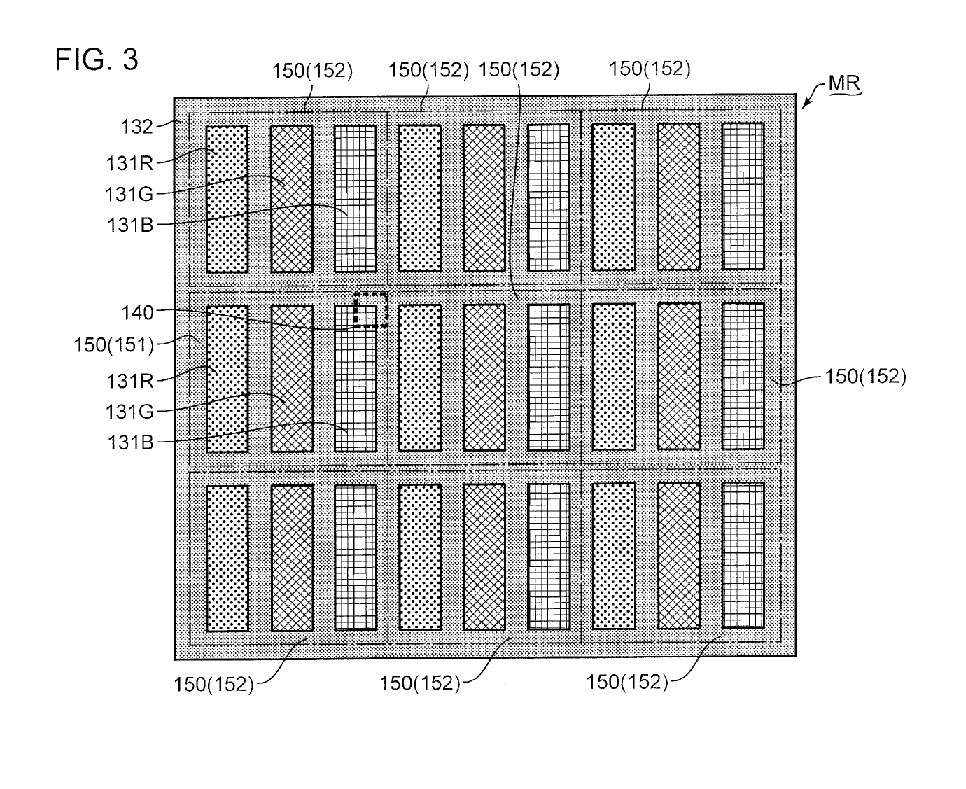

FIG. 3 is a schematic view of pixels 150 in the rectangular frame MR. The pixels 150 are described with reference to FIGS. 2 and 3.

FIG. 3 shows nine pixels 150. The chain line shown in FIG. 3 conceptually compartmentalizes the nine pixels 150.

As described above, each pixel 150 includes the R sub-pixel defined by the R filter 131R, the G sub-pixel defined by the G filter 131G, the B sub-pixel defined by the B filter 131B, and the black matrix 132 compartmentalizing the R, G and B sub-pixels.

In FIG. 3, the spacer 140 is shown by a dot line. The spacer 140 interferes with the B filter 131B of one of the nine pixels 150. In the following description, the pixel 150, which specifically has a region of the B filter 131B interfering with the spacer 140, is referred to as “first pixel 151”. Other eight pixels 150 are referred to as “second pixels 152”. In the present embodiment, the spacer 140 is exemplified as the interfering member.

As shown in FIG. 2, the rectangular frame MR is a part of the display surface (on which images are displayed) of the liquid crystal panel 100. Therefore, the liquid crystal panel 100 includes a plurality of the first pixels 151 and a plurality of the second pixels 152. The first and second pixels 151, 152 are arranged in a matrix over the display surface. The first pixels 151 including the interference region created by the spacer 140 are distributed with a constant density over the entire display surface of the liquid crystal panel 100. In the present embodiment, one spacer 140 is arranged substantially every nine pixels. Therefore, there are less interference regions of the spacers 140 in an image displayed by the liquid crystal panel 100 of the present embodiment, in comparison to a typical structure which allocates one spacer to every pixel to maintain a gap of a liquid crystal layer. Consequently, a viewer viewing images is less likely to perceive a decrease in brightness caused by the spacers 140.

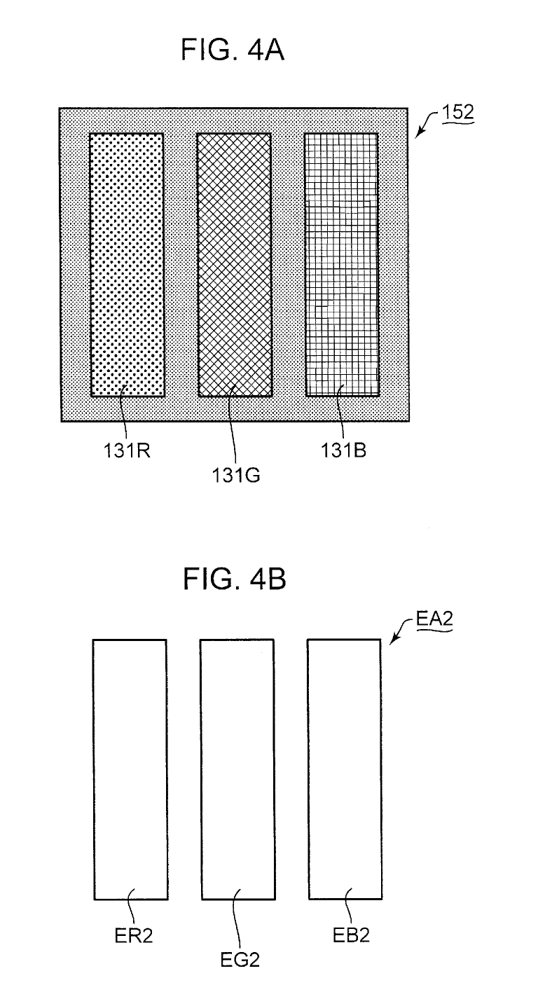

FIG. 4A is a schematic view of the second pixel 152. FIG. 4B is a schematic view of an emission region EA2 of the second pixel 152 from which image light is emitted to display images. The emission region EA2 of the second pixel 152 is described with reference to FIGS. 3 to 4B.

The emission region EA2 of the second pixel 152 includes an R emission region ER2, from which the red light generated by the R filter 131R is emitted, a G emission region EG2, from which the green light generated by the G filter 131G is emitted, and a B emission region EB2, from which the blue light generated by the B filter 131B is emitted. The spacers 140 do not interfere with the R, G and B filters 131R, 131G, 131B of the second pixel 152. Therefore, the R emission region ER2 is substantially as large as the R filter 131R. The G emission region EG2 is substantially as large as the G filter 131G. The B emission region EB2 is substantially as large as the B filter 131B. The emission region EA2 is exemplified as the second emission region.

According to the spectral luminous efficiency curve, the blue light has the lowest contribution ratio to luminance. The green light has the highest contribution ratio to luminance. The red light has a higher contribution ratio than the blue light and a lower contribution ratio than the green light. In the present embodiment, the B emission region EB2 to emit the blue light is exemplified as the first transmission region. The G emission region EG2 to emit the green light and/or the R emission region ER2 to emit the red light are exemplified as the second transmission region.

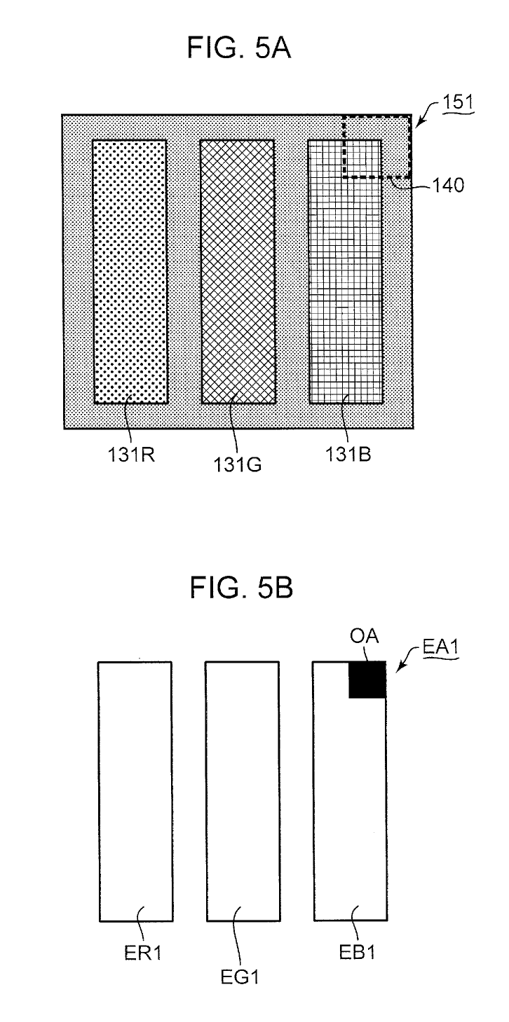

FIG. 5A is a schematic view of the first pixel 151. FIG. 5B is a schematic view of the emission region EA1 of the first pixel 151 from which image light is emitted to display images. The emission region EA1 of the first pixel 151 is described with reference to FIGS. 4A to 5B.

The emission region EA1 of the first pixel 151 includes an R emission region ER1, from which a red light generated by the R filter 131R is emitted, a G emission region EG1, from which a green light generated by the G filter 131G is emitted, and a B emission region EB1, from which a blue light generated by the B filter 131B is emitted. The spacer 140 depicted by a dot line in FIG. 5A does not overlap the R and G filters 131R, 131G of the first pixel 151 except for the B filter 131B of the first pixel 151. In FIG. 5B, an overlapping region OA in which the spacer 140 overlaps the B filter 131B is shown as a black region. In the present embodiment, the emission region EA1 is exemplified as the first emission region.

The spacer 140 in the overlapping region OA blocks light directed toward the B filter 131B. Consequently, the image light (blue light) is not emitted from the overlapping region OA. Therefore, the overlapping region OA is excluded from the emission region EA1. /

The R filter 131R of the first pixel 151 is substantially as large as the R filter 131R of the second pixel 152. The G filter 131G of the first pixel 151 is substantially as large as the G filter 131G of the second pixel 152. The B filter 131B of the first pixel 151 is substantially as large as the B filter 131B of the second pixel 152.

The R emission region ER1 of the first pixel 151 is substantially as large as the R emission region ER2 of the second pixel 152. The G emission region EG1 of the first pixel 151 is substantially as large as the G emission region EG2 of the second pixel 152. However, the B emission region EB1 of the first pixel 151 is narrower than the B emission region EB2 of the second pixel 152 by an area size of the overlapping region OA. Thus, the emission region EA1 of the first pixel 151 is narrower than the emission region EA2 of the second pixel 152 by the area size of the overlapping region OA.

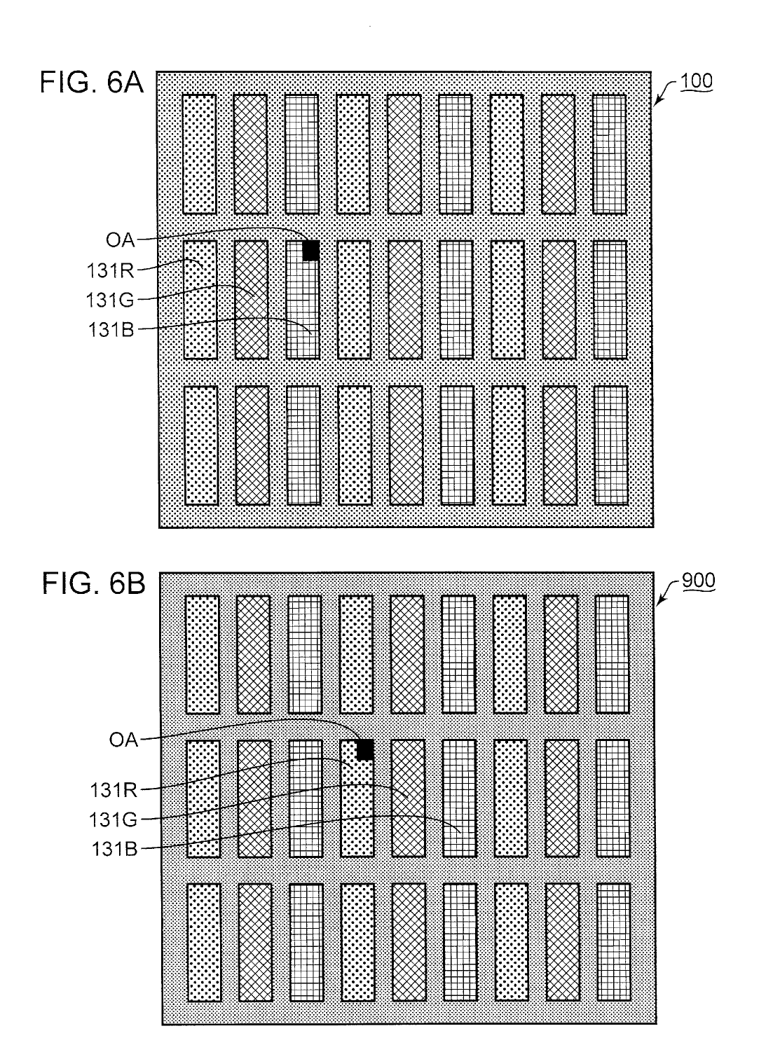

FIG. 6A is a schematic view of pixel arrangement in the liquid crystal panel 100. FIG. 6B is a schematic view of pixel arrangement in another liquid crystal panel 900. Differences between the liquid crystal panels 100, 900 are described with reference to FIGS. 6A and 6B.

As described above, the overlapping region OA is formed in correspondence to the B filter 131B of the liquid crystal panel 100. On the other hand, the overlapping region OA of the liquid crystal panel 900 is formed in correspondence to the R filter 131R.

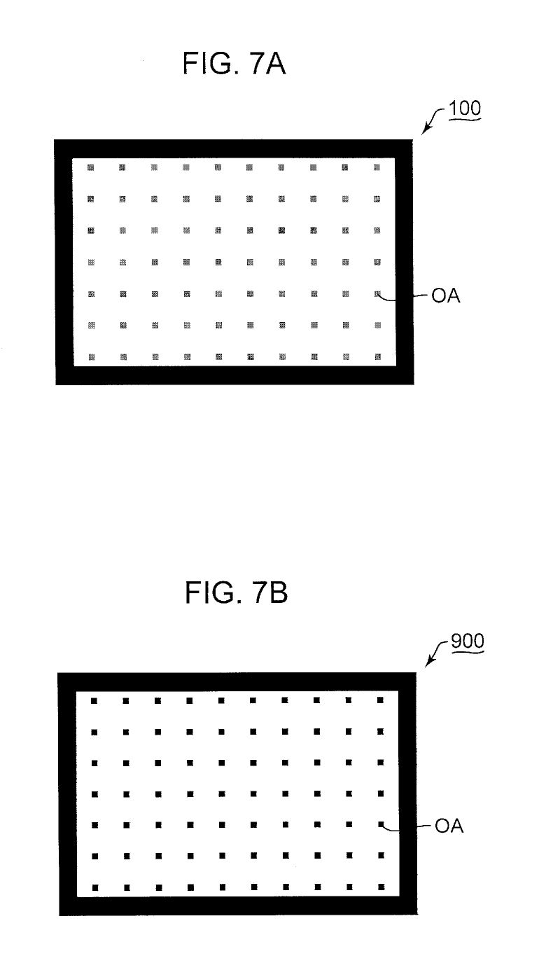

FIG. 7A shows simulation results for an image formed on the display surface under display of a white image on the liquid crystal panel 100. FIG. 7B shows simulation results for an image formed on the display surface under display of a white image on the liquid crystal panel 900. The simulation results are described with reference to FIGS. 6A to 7B.

As described above, since no image light is emitted from the overlapping region OA, an observer perceives the overlapping region OA darker than other regions. In FIGS. 7A and 7B, the overlapping regions OA are arranged in a matrix in the display surfaces of the liquid crystal panels 100, 900.

As described with reference to FIG. 6A, the overlapping region OA in the liquid crystal panel 100 is formed in correspondence to the B filter 131B. The blue light emitted from the B filter 131B has the lowest contribution ratio to luminance if the ratio is based on the spectral luminous efficiency curve. Therefore, the observer is less likely to perceive localized darkness in images caused by the overlapping regions OA corresponding to the B filters 131B.

As described with reference to FIG. 6B, the overlapping region OA in the liquid crystal panel 900 is formed in correspondence to the R filter 131R to emit a red light with a relatively high contribution ratio to luminance. Therefore, an observer may be likely to perceive the localized darkness in images caused by the overlapping regions OA corresponding to the R filters 131R.

In the present embodiment, the overlapping region OA is formed in correspondence to the B filter 131B. The overlapping region OA corresponding to the B filter 131B reduces an amount of the blue light. Since the blue light amount is reduced, a hue of image light emitted from the liquid crystal panel 100 shifts to the yellow hue which is a complementary color of the blue hue. Since the yellow hue has high relative luminosity, an observer is less likely to perceive a decrease in luminance.

Unlike the following second embodiment, in the present embodiment, the spacer 140 interferes with a region of the B filter 131 B without interference with other filter regions (R and G filters 131R, 131G). Therefore, the filter arrangement in the first pixel does not limit the principles of the present embodiment. For example, the B filter may be situated between the R and G filters in the first pixel.

### Second Embodiment

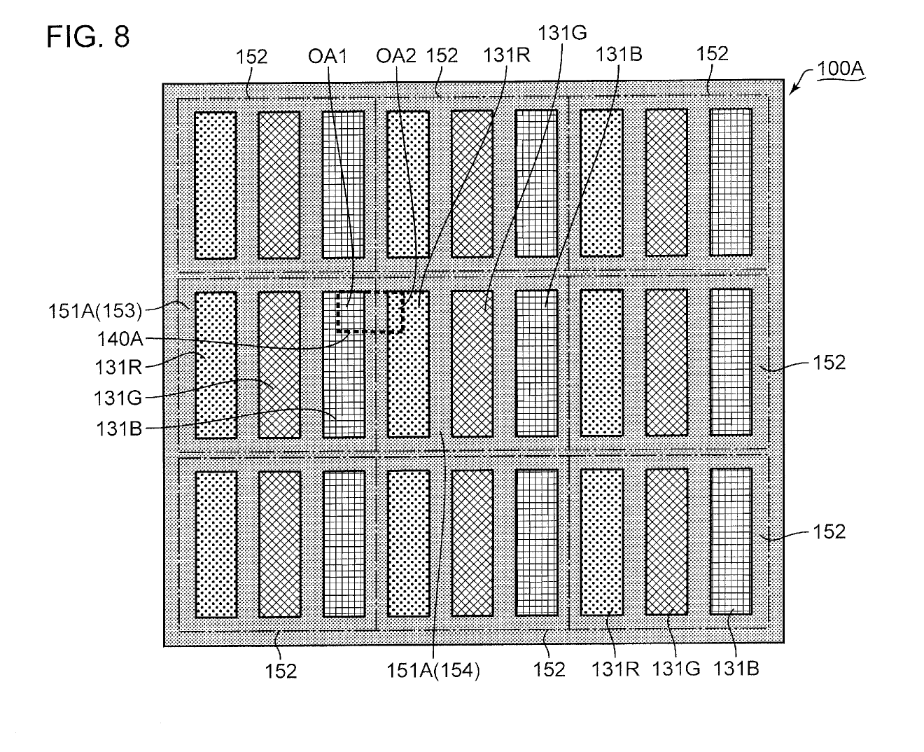

FIG. 8 is a schematic view of pixel arrangement in a liquid crystal panel 100A exemplified as the display device according to the second embodiment. The same elements as the first embodiment are assigned with the same reference numerals. The description in the context of the first embodiment may be advantageously applied to the elements which are not described below. Pixels of the liquid crystal panel 100A are described with reference to FIG. 8.

Like the first embodiment, the liquid crystal panel 100A includes the R, G and B filters 131R, 131G, 131B, and black matrix 132. FIG. 8 schematically shows two first pixels 151A and seven second pixels 152. In the following description, one of the two first pixels 151A is referred to as “first adjacent pixel 153” whereas the other pixel is referred to as “second adjacent pixel 154”. The first adjacent pixel 153 is adjacent on the left to the second adjacent pixel 154. In the present embodiment, the first and second adjacent pixels 153, 154 are exemplified as the pair of adjacent pixels.

In the first pixel 151A, the G filter 131G is situated between the R and B filters 131R, 131B. The R filter 131R is situated on the left of the G filter 131G. The B filter 131B is situated on the right of the G filter 131G. Therefore, the B filter 131B of the first adjacent pixel 153 is adjacent to the R filter 131R of the second adjacent pixel 154.

The liquid crystal panel 100A further includes a spacer 140A. Like the first embodiment, the spacer 140A is used to maintain the gap of the liquid crystal layer in the liquid crystal panel 100A. The spacer 140A overlaps a region of the B filter 131B of the first adjacent pixel 153 and a region of the R filter 131R of the second adjacent pixel 154. In the following description, the region in which the spacer 140A overlaps the B filter 131B of the first adjacent pixel 153 is referred to as “first overlapping region OA1”. In the following description, the region in which the spacer 140A overlaps the R filter 131R of the second adjacent pixel 154 is referred to as “second overlapping region OA2”. In the present embodiment, the spacer 140A is exemplified as the interfering member.

As described in the context of the first embodiment, the blue light emitted from the B filter 131B has the lowest contribution ratio to luminance. In the following description, the contribution ratio of the blue light is referred to as “first contribution ratio”. In the present embodiment, the region of the B filter 131B except for the first overlapping region OA1 is exemplified as the first transmission portion.

The red light emitted from the R filter 131R has the second lowest contribution ratio next to the blue light. In the following description, the contribution ratio of the red light is referred to as “second contribution ratio”. In the present embodiment, the region of the R filter 131R except for the second overlapping region OA2 is exemplified as the second transmission portion.

As shown in FIG. 8, the first overlapping region OA1 is larger than the second overlapping region OA2. A relationship between the first and second overlapping regions OA1, OA2 is described below.

The “first and second contribution ratios” used in the following description are determined on the basis of the spectral luminous efficiency curve (spectral luminous efficiency function). In the present embodiment, the blue light having the first contribution ratio is exemplified as the image light of the first hue, and the red light having the second contribution ratio is exemplified as the image light of the second hue.

If a liquid crystal display system conforms to the NTSC RGB standard in terms of color gamut, it is known that the relationship represented by the following equation is generally satisfied between the first contribution ratio (blue light) and second contribution ratio (red light). In the following equation, the reference symbol “C1” represents the first contribution ratio whereas the reference symbol “C2” represents the second contribution ratio.

C1:C2=1:3 [Eqn 1]

A area size ratio between the first and second overlapping regions OA1, OA2 is determined on the basis of an inverse number of the ratio between the first and second contribution ratios. In the present embodiment, the area size ratio between the first and second overlapping regions OA1, OA2 is represented by the following equation. In the following equation, the reference symbol “A1” represents an area size of the first overlapping region OA1 whereas the reference symbol “A2” represents an area size of the second overlapping region OA2.

A1=3×A2 [Eqn 2]

In the present embodiment, the spacer 140A overlaps the color filters (B and R filters 131B, 131R) from which image lights with hues having relatively low contribution ratios to luminance is emitted. Therefore, like the first embodiment, an observer is less likely to perceive a decrease in luminance. In addition, the overlapping regions are distributed in several sub-pixels. Therefore, for example, if monochromatic blue is displayed as an image, a decrease in luminance becomes less noticeable than the first embodiment. The area size ratio between the overlapping regions is set to an inverse number of a ratio between contribution ratios. Therefore, an observer is less likely to perceive a decrease in luminance.

In the present embodiment, the first and second overlapping regions OA1, OA2 cover two pixels (first and second adjacent pixels 153, 154). Alternatively, the overlapping regions may cover two filter regions in a single pixel. For example, R, B and G filters may be sequentially arranged in a single pixel. If a spacer is situated between the R and B filters, the spacer interferes with two filter regions in a single pixel. The principle about the allocation of overlapping regions on the basis of contribution ratios according to the present embodiment may be advantageously applied to arrangement of spacers interfering with the two filter regions in a single pixel. Consequently, an observer is less likely to perceive a resultant decrease in luminance from the spacers.

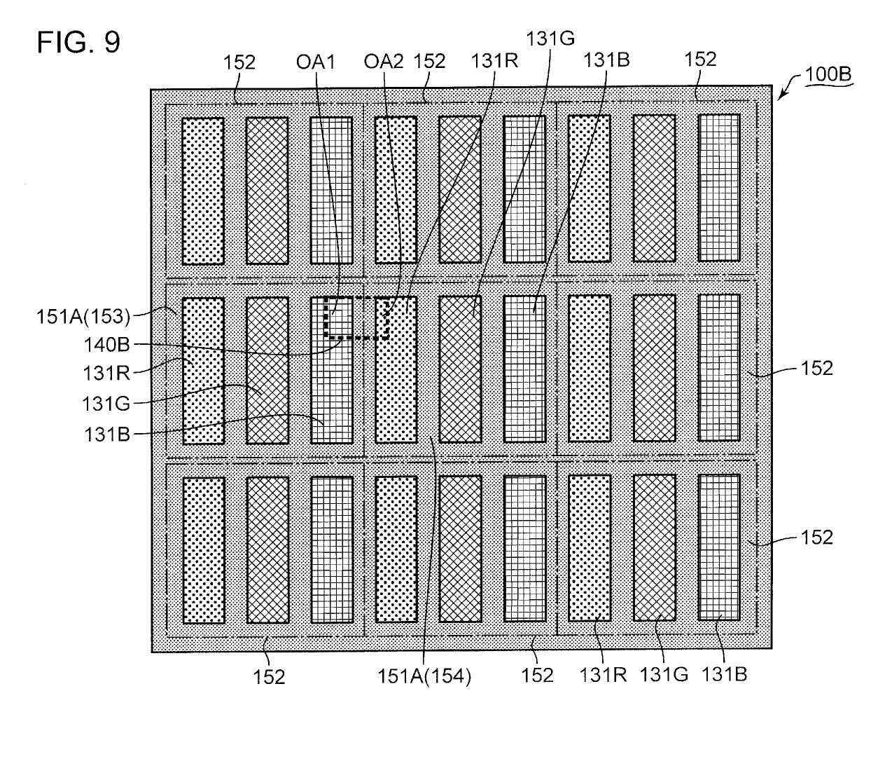

FIG. 9 is a schematic view of pixel arrangement in another liquid crystal panel 100B exemplified as the display device according to the second embodiment. Similar elements to those of the aforementioned liquid crystal panel 100A are assigned with similar reference numerals. The description about the liquid crystal panel 100A may be applied to these elements, which are not described below. Pixels of the liquid crystal panel 100B are described with reference to FIG. 9.

Instead of the spacer 140A, the liquid crystal panel 100B includes a sensor 140B configured to detect a movement of an object (e.g. a human hand or a touch pen) on the display surface, on which images are displayed, or a pressure from the object. Therefore, the liquid crystal panel 100B may be used as a touch panel.

Like the aforementioned spacer 140A, the sensor 140B forms the first and second overlapping regions OA1, OA2. In the present embodiment, the sensor 140B is exemplified as the interfering member.

The principle of the present embodiment allows the interfering members to be arranged over several pixels. Therefore, the sensor 140B may detect a movement or a pressure of or from an object in a wide region.

The principles of the aforementioned embodiments may be applied to other display devices. For example, a display device may use light emission of organic EL elements to display images. According to the principles of the aforementioned embodiments, a resultant decrease in luminance from spacers situated between a pair of substrates to confine the organic EL elements becomes less noticeable.

In the aforementioned embodiments, the spacers and sensors are exemplified as the interfering members. Alternatively, other members interfering with pixels may be the interfering members. According to the principles of the aforementioned embodiments, a resultant decrease in luminance from various members interfering with pixels may become less noticeable.

The aforementioned embodiments mainly include the display devices having the following features.

In one general aspect, the instant application describes a display device that includes first pixels each of which has a first emission region configured to emit image light for displaying an image; and second pixels each of which has a second emission region configured to emit the image light, wherein each of the first pixels and each of second pixels have optical transmission sections which emit different image lights in hue from each other, the optical transmission sections forms a first transmission region configured to emit an image light of a hue which has a predetermined contribution ratio to luminance, and a second transmission region configured to emit an image light of a hue with a contribution ratio higher than that of the first transmission region, and the first emission region is narrower than the second emission region by a difference in area size between the first transmission regions in the first and second emission regions.

According to the aforementioned configuration, the image light is emitted from the first and second emission regions of the first and second pixels to display an image. Since each of the first and second pixels has optical transmission sections to emit different image lights in hue from each other, the display device may display an image with several hues.

The optical transmission sections form the first and second transmission regions. The first emission region is narrower than the second emission region by a difference in area size between the first transmission regions in the first and second emission regions. Since the hue of the image light emitted from the first transmission region has a lower contribution ratio to luminance than that of the hue of the image light emitted from the second transmission region, an observer is less likely to perceive the difference in area size between the first and second emission regions. Therefore, the display device may display high quality images.

The above general aspect may include one or more of the following features. The first transmission region may be narrower in the first emission region than the second emission region, and the second transmission region in the first emission region may be as large as the second transmission region in the second emission region.

According to the aforementioned configuration, since the hue of the image light emitted from the first transmission region has a lower contribution ratio to luminance than that of the hue of the image light emitted from the second transmission region, an observer is less likely to perceive the difference in area size between the first transmission regions in the first and second emission regions.

Since the image light with a hue having a higher contribution ratio to luminance than that of the hue of the image light emitted from the first transmission region is emitted from the second transmission region, which is few difference in area size between the first and second emission regions, the display device may display high quality images.

The display device may further include a first substrate configured to define a display surface on which the image is displayed; a second substrate configured to face the first substrate; and an interfering member situated between the first and second substrates to interfere with at least one of the first pixels, wherein the at least one of the first pixels has an overlapping region which overlaps the interfering member, and the overlapping region corresponds to the difference in the area size.

According to the aforementioned configuration, the interfering member situated between the first substrate which defines the display surface to display the image, and the second substrate facing the first substrate interferes with the first pixel. The first pixel has the overlapping region which overlaps the interfering member. The overlapping region corresponds to the difference in area size. Therefore, an observer is less likely to perceive presence of the interfering member in the image.

The interfering member may be a spacer configured to maintain a gap between the first and second substrates.

According to the aforementioned configuration, since the interfering member is a spacer configured to maintain a gap between the first and second substrates, the display device may display high quality images for a long time.

The interfering member may be a sensor configured to detect a movement of an object on the display surface.

According to the aforementioned configuration, since the interfering member is a sensor for detecting an movement of an object on the display surface, the display device may be used as a touch panel device.

The first transmission region may include a first transmission portion with a lowest contribution ratio to luminance in the optical transmission sections.

According to the aforementioned configuration, since the first transmission region includes a first transmission portion with the lowest contribution ratio to luminance among the optical transmission sections, an observer is less likely to perceive the difference in area size between the first and second emission regions. Therefore, the display device may display high quality images.

The first transmission region may include a second transmission portion with a second lowest contribution ratio next to the first transmission portion.

According to the aforementioned configuration, since the first transmission region includes a second transmission portion with the second lowest contribution ratio next to the first transmission portion, an observer is less likely to perceive the difference in area size between the first and second emission regions. Therefore, the display device may display high quality images.

The overlapping region may include a first overlapping region in which the interfering member overlaps the first transmission region, and a second overlapping region in which the interfering member overlaps the second transmission region, and the first overlapping region may be wider than the second overlapping region.

According to the aforementioned configuration, since the first overlapping region is wider than the second overlapping region, an observer is less likely to perceive the difference in area size between the first and second emission regions. Therefore, the display device may display high quality images.

The first transmission portion may emit an image light of a first hue which has a first contribution ratio determined according to a spectral luminous efficiency curve, the second transmission portion may emit an image light of a second hue which has a second contribution ratio determined according to the spectral luminous efficiency curve, and an area size ratio between the first and second overlapping regions is determined by an inverse number of a ratio between the first and second contribution ratios.

According to the aforementioned configuration, since the area size ratio between the first and second overlapping regions is determined by an inverse number of a ratio between the first and second contribution ratios, an observer is less likely to perceive presence of the interfering member.

The first pixels may include a pair of adjacent pixels, and the first transmission portion of one of the pair of the adjacent pixels may be adjacent to the second transmission portion of another of the pair of the adjacent pixels.

According to the aforementioned configuration, since the first transmission portion of one of the pair of adjacent pixels is adjacent to the second transmission portion of the other pixel, the interfering member may be arranged over a few pixels.

The contribution ratio may be determined according to a spectral luminous efficiency curve.

According to the aforementioned configuration, since the arrangement of the interfering member is determined on the basis of a contribution ratio determined according to a spectral luminous efficiency curve, an observer is less likely to perceive presence of the interfering member.

The optical transmission sections may include a blue filter, which transmits a blue image light, a red filter, which transmits a red image light, and a green filter, which transmits a green image light, the first transmission portion may be the blue filter, and the second transmission portion may be the red filter.

According to the aforementioned configuration, since the optical transmission sections includes a blue filter, which allows transmission of a blue image light, a red filter, which allows transmission of a red image light, and a green filter, which allows transmission of a green image light, image light is created from three primary colors. Since the first transmission portion is the blue filter and the second transmission portion is the red filter, an observer is less likely to perceive presence of the interfering member.

The first and second pixels may be arranged in a matrix over the display surface, and the first pixels is distributed with a constant density over the display surface.

According to the aforementioned configuration, the first and second pixels may be arranged in a matrix over the display surface. Since the first pixels are distributed with a constant density in the display surface, areas which have low brightness are less likely to congregate.

### INDUSTRIAL APPLICABILITY

The principles of the embodiments may be advantageously used for display devices having a fine pixel structure.

This application is based on Japanese Patent application No. 2012-099699 filed in Japan Patent Office on Apr. 25, 2012, the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

What is claimed is:

1. A display device comprising:
first pixels each of which has a first emission region configured to emit image light for displaying an image; and
second pixels each of which has a second emission region configured to emit the image light, wherein
each of the first pixels and each of second pixels have optical transmission sections which emit different image lights in hue from each other,
the optical transmission sections forms a first transmission region configured to emit an image light of a hue which has a predetermined contribution ratio to luminance, and a second transmission region configured to emit an image light of a hue with a contribution ratio higher than that of the first transmission region, and
the first emission region is narrower than the second emission region by a difference in area size between the first transmission regions in the first and second emission regions.

2. The display device according to claim 1, wherein
the first transmission region is narrower in the first emission region than the second emission region, and
the second transmission region in the first emission region is as large as the second transmission region in the second emission region.

3. The display device according to claim 1, further comprising:
a first substrate configured to define a display surface on which the image is displayed;
a second substrate configured to face the first substrate; and
an interfering member situated between the first and second substrates to interfere with at least one of the first pixels, wherein
the at least one of the first pixels has an overlapping region which overlaps the interfering member, and
the overlapping region corresponds to the difference in the area size.

4. The display device according to claim 3, wherein
the interfering member is a spacer configured to maintain a gap between the first and second substrates.

5. The display device according to claim 3, wherein
the interfering member is a sensor configured to detect a movement of an object on the display surface.

6. The display device according to claim 3, wherein
the first transmission region includes a first transmission portion with a lowest contribution ratio to luminance in the optical transmission sections.

7. The display device according to claim 6, wherein
the first transmission region includes a second transmission portion with a second lowest contribution ratio next to the first transmission portion.

8. The display device according to claim 7, wherein
the overlapping region includes a first overlapping region in which the interfering member overlaps the first transmission region, and a second overlapping region in which the interfering member overlaps the second transmission region, and
the first overlapping region is wider than the second overlapping region.

9. The display device according to claim 8, wherein
the first transmission portion emits an image light of a first hue which has a first contribution ratio determined according to a spectral luminous efficiency curve,
the second transmission portion emits an image light of a second hue which has a second contribution ratio determined according to the spectral luminous efficiency curve, and
an area size ratio between the first and second overlapping regions is determined by an inverse number of a ratio between the first and second contribution ratios.

10. The display device according to claim 7, wherein
the first pixels includes a pair of adjacent pixels, and
the first transmission portion of one of the pair of the adjacent pixels is adjacent to the second transmission portion of another of the pair of the adjacent pixels.

11. The display device according to claim 1, wherein
the contribution ratio is determined according to a spectral luminous efficiency curve.

12. The display device according to claim 7, wherein
the optical transmission sections includes a blue filter, which transmits a blue image light, a red filter, which transmits a red image light, and a green filter, which transmits a green image light,
the first transmission portion is the blue filter, and
the second transmission portion is the red filter.

13. The display device according to claim 3, wherein
the first and second pixels are arranged in a matrix over the display surface, and
the first pixels is distributed with a constant density over the display surface.
